(19) United States
(12) Patent Application Publication
(10) Pub. No.: US 2014/0359973 A1
(43) Pub. Date: Dec. 11, 2014

(54) BLIND HINGE USED FOR FURNITURE

(71) Applicant: GUANGDONG TAIMING METAL PRODUCTS CO. LTD, Foshan City (CN)

(72) Inventor: Tai Wai NG, Foshan City (CN)

(21) Appl. No.: 14/288,837

(22) Filed: May 28, 2014

(30) Foreign Application Priority Data
Jun. 7, 2013 (CN) 201320326630.0

(51) Int. Cl. E05D 7/00

(52) U.S. Cl. CPC E05D 7/00
USPC 16/225

(57) ABSTRACT

A blind hinge used for furniture, comprising a movable cup seat provided on the furniture door body, a regulating base provided on the main body of furniture, a rotary arm connected between the movable cup seat and the regulating base as well as an elastic element designed to generate start-stop acting force on the movable cup seat at least, characterized in that, the front of the rotary arm is designed as similar “ [symbol] ”-shaped structure, the small end arm lever is hinged with the movable cup seat through pin shaft and forms an arc-shaped surface connected with the elastic element; The big end top surface is a plane; a bending part which is bent downwards on the rear end of the rotary arm is connected with the regulating base.

### NOTICE OF COPYRIGHTS AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by anyone of the patent disclosure as it appears in the Patent and Trademark Office patent files or records, but otherwise reserves all copyright and trade dress rights whatsoever.

### RELATED APPLICATION INFORMATION

This patent claims the benefit of priority to Chinese Patent Application No. 201320326630.0, filed Jun. 7, 2013, of which full contents are incorporated herein by reference.

### BACKGROUND

1. Field

The present utility model relates to a blind hinge used for furniture.

2. Description of the Related Art

On May 17, 2006, Chinese patent(patent number: CN2780937Y) disclosed a blind hinge for furniture door which can make regulation in three-dimensional direction, comprising a movable base which can be fixed on the door body, an adjustable base which can be fixed on the door frame and a rotary arm which is connected between the movable base and the adjustable base, wherein the adjustable base comprises a base plate which can be fixed on the door frame, a middle plate which is designed to slide up and down on the base plate and a upper regulating plate which is designed to slide forward or backward on the middle plate, that is to say, the base on the door frame is designed as three-layer plate structure; The plates are formed through alloy casting and then riveted with the lower-layer regulating plate through re-extrusion. Although the production process of this utility model is simple, this process brings hidden troubles to the quality of hinge. After the alloy casting has undergone re-extrusion, there are changes in the internal structure of such material, such as loose and cracking. Therefore, it is difficult to guarantee the reliability of riveting between the alloy casting and the upper-layer regulating plate, so thon the hinge does not have high strength and the door sheet may easily drop. In addition, this utility model has such deficiencies as short service life, complicated structure and high production cost. Therefore, it is necessary to make further improvement.

### DESCRIPTION OF UTILITY MODEL

It is the technical objective of the present utility model to provide a blind hinge for furniture featured by simple and reasonable structure, reliable performance, simple manufacturing process, low production cost, high structural strength, long service life, esthetic appearance and good practicability, so as to overcome the deficiencies in the prior art.

A blind hinge used for furniture which is designed according to this technical objective, comprising a movable cup seat (1) provided on the furniture door body, a regulating base provide on the main body of furniture, an regulating base provided on the main body of furniture, a rotary arm connected between the movable cup seat and the regulating base as well as an elastic element designed to generate start-stop acting force on the movable cup seat at least, characterized in that, the front of the rotary arm is designed as similar “ [symbol] ”-shaped structure, the small end arm lever is hinged with the movable cup seat through pin shaft and forms an arc-shaped surface connected with the elastic element; The big end top surface is a plane; a bending part which is bent downwards on the rear end of the rotary arm is connected with the regulating base.

The elastic element is a torsion spring, wherein two torsion springs are respectively mounted on the notches on both sides at the bottom of the movable cup seat; The torsion spring at least comprises a first supporting leg with one end extending into the cup body of the movable cup seat and being connected with it as well as a second supporting leg with another end being extended into the cup body of movable cup seat and being connected with the arc-shaped surface, wherein the free end of the first supporting leg is bent, and its end surface is connected with the bottom wall of the movable cup seat.

The regulating base is a movable plate, wherein the rotary arm is connected with the movable plate through a regulating screw and an eccentric regulating rivet, so as to realize the two-dimensional regulation of the furniture door body.

A open slot is provided on the front end of the movable plate, a first regulating hole is provided on the rotary arm corresponding to the open slot, and both the open slot and the first regulating hole are in coordinated connection through the regulating screw (6); a hole is provided on the moveable plate, a second regulating hole is provided on the bending part of the rotary arm corresponding to the hole , and both the hole and the second regulating hole are in coordinated connection through the eccentric regulating rivet.

Both sides of the rotary arm are bent downwards to form a slot which is in limiting connection with the movable plate, a boss is provided on the movable plate and is in coordinated connection with the rotary arm (2), and at least two corners of movable plate are bent downwards to form a claw.

The regulating base is composed of a movable plate and a base plate, wherein the movable plate 3 is positioned between the base plate 4 and the rotary arm , the rotary arm is connected with the movable plate through the regulating screw and the eccentric regulating rivet, the movable plate is connected with the base plate through another eccentric regulating rivet, so as to realize the three-dimensional regulation of furniture door body.

A open slot is provided on the front end of the movable plate, a first regulating hole is provided to the rotary arm corresponding to the open slot, and both the open slot and the first regulating hole are in coordinated connection through the regulating screw (6); an another hole is also provided on the moveable plate, a matching hole is provided on the base plate corresponding to the hole, and both the hole and the matching hole are in coordinated connection through eccentric regulating rivet.

One regulating screw and two eccentric regulating rivets are in triple-lapped arrangement.

Both sides of the rotary arm are bent downwards to form a slot which is in limiting connection with the movable plate, a boss is provided on the movable plate (3) and is in coordinated connection with the rotary arm; the outside of the base plate is bent towards the direction of movable plate and forms a guide slot, the movable plate is slideably provided on the guide slot, and at least two corners of the base plate are bent downwards to form a blocking part.
Both the rotary arm and the regulating base are molded by integrated stamping and bending of metal.

Through the improvement of the said structure, the bending part is bent downwards on the rear end of the rotary arm and is connected with the regulating base, so thon the structure between the rotary arm and the regulating base has even higher firmness, and both the structural strength and service life of the blind hinge used for furniture are improved; In addition, the elastic element is directly set on the notch of the movable cup seat without need for any component, so thon the manufacturing process is further simplified and the production cost is reduced. Furthermore, the present utility model is featured by simple and reasonable structure, reliable performance, high structural strength, esthetic appearance and practical application.

### DESCRIPTION OF THE DRAWINGS

FIG. 1 is the breakdown structure diagram of an embodiment of the present utility model.

FIG. 2 is the structure diagram of an embodiment of the present utility model.

FIG. 3 is the structure diagram of the rotary arm.

FIG. 4 is the connection structure diagram of the movable cup seat and the elastic element.

FIG. 5 is the breakdown structure diagram of another embodiment of the present utility model.

FIG. 6 is the structure diagram of another embodiment of the present utility model.

FIG. 7 is the structure diagram of the rotary arm of another embodiment of the present utility model.

FIG. 8 is the breakdown structure diagram of the third embodiment of the present utility model.

FIG. 9 is the structure diagram of the third embodiment of the present utility model.

FIG. 10 is the structure diagram of the rotary arm of the third embodiment of the present utility model.

### DETAILED DESCRIPTION

Further detailed description of the present utility model is provided with reference to specific embodiments in combination with attached drawings.

### The First Embodiment

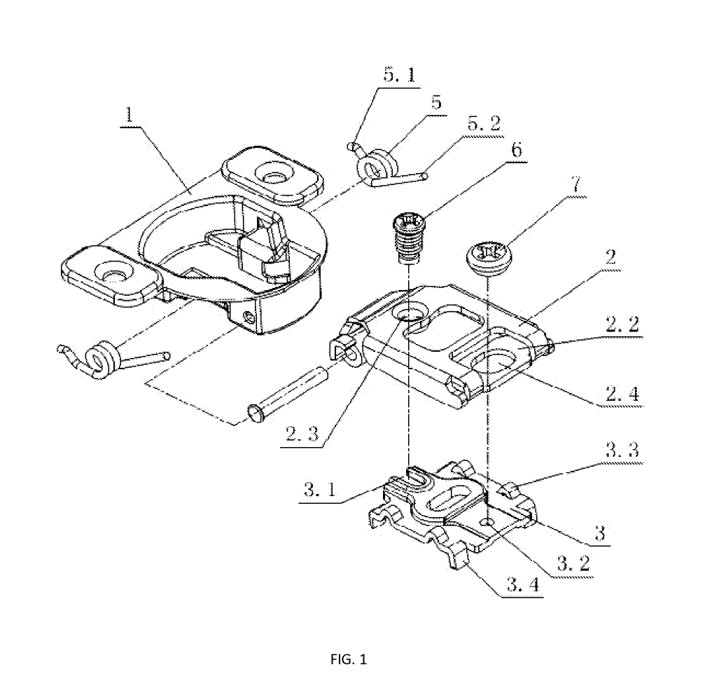

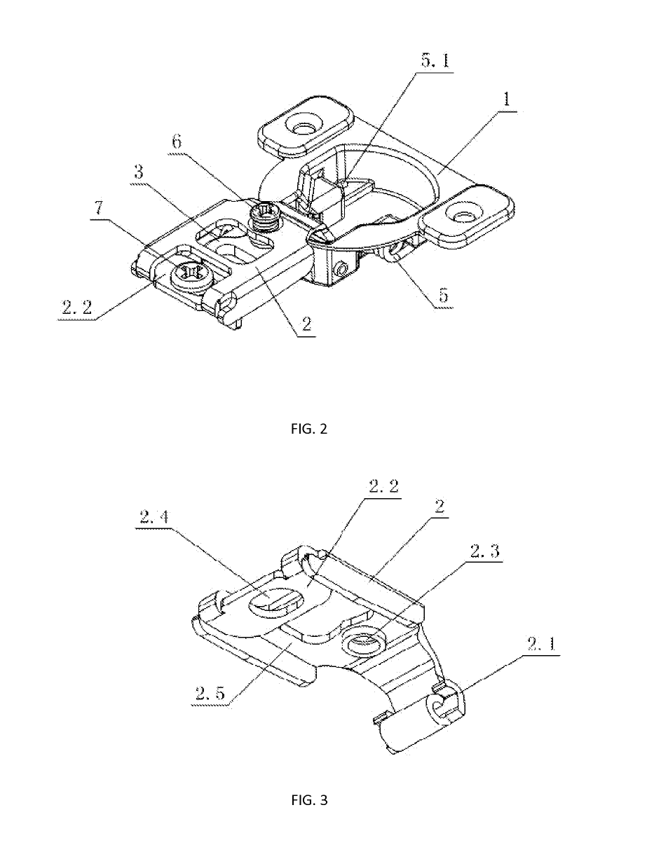

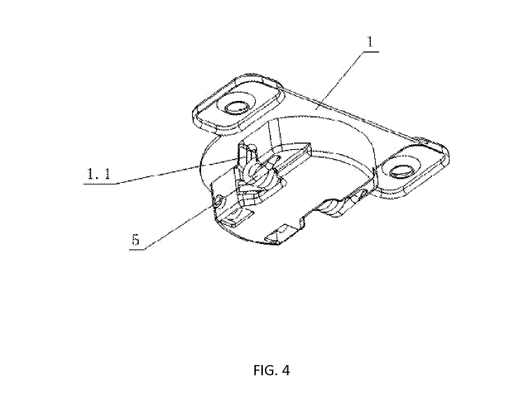

With reference to FIGS. 1-4, a blind hinge for furniture, comprising a movable cup seat 1 provided on the furniture door body, a regulating base provided on the main body of furniture, an regulating base provided on the main body of furniture, a rotary arm 2 connected between the movable cup seat 1 and the regulating base as well as an elastic element designed to generate start-stop acting force on the movable cup seat 1 at least, characterized in that, the front of the rotary arm 2 is designed as similar “ [symbol] ”- shaped structure, the small end arm lever is hinged with the movable cup seat through pin shaft and forms an arc-shaped surface connected with the elastic element; the big end top surface is designed as a plane, so as to ensure the smoothness for its combination with furniture and improve the aesthetic effect of hinge; a bending part 2.2 which is bent downwards on the rear end of the rotary arm is connected with the regulating base.

The elastic element is a torsion spring 5, wherein two torsion springs 5 are directly inserted on the notches 1.1 on both sides at the bottom of the movable cup seat 1, without need for any component; The torsion spring 5 at least comprises a first supporting leg with one end extending into the cup body of the movable cup seat 1 and being connected with it as well as a second supporting leg with another end being extended into the cup body of movable cup seat 1 and being connected with the arc-shaped surface 2.1, wherein the free end of the first supporting leg 5.1 is bent until and its end surface is connected with the bottom wall of the movable cup seat 1.

In the said structure, the regulating base is a movable plate 3, the rotary arm 3 is connected with the movable plate 3 through a regulating screw 6 and an eccentric regulating rivet 7, so as to realize the two-dimensional regulation of furniture door body. Specifically, a open slot 3.1 is provided on the front end of the movable plate 3, a first regulating hole 2.3 is provided on the rotary arm 2 corresponding to the open slot 3.1, and both the open slot 3.1 and the first regulating hole 2.3 are in coordinated connection through regulating screw 6; a hole 3.2 is provided on the movable plate 3, a second regulating hole 2.4 is provided on the bending part 2.2 of rotary arm 2 corresponding to the hole 3.2, and both the hole 3.2 and the second regulating hole 2.4 are in coordinated connection through the eccentric regulating rivet 7.

In order thon the connection and regulation between the rotary arm 2 and the movable plate 3 are more reasonable, both sides of the rotary arm 2 are bent downwards to form a slot 2.5 which is in limiting connection with the movable plate 3, a boss 3.3 is provided on the movable plate 3 and is in coordinated connection with the rotary arm 2, wherein the boss 3.3 is a bump, and four bumps are respectively provided on the upper and lower ends on the left and right sides of the movable plate 3, and the four corners of the movable plate are bent downwards to form a claw 3.4, which is embedded in the main body frame of furniture to realize the positioning of the movable plate 3.

Both the rotary arm 2 and the movable plate 3 are molded by integrated stamping and bending of metal.

### The Second Embodiment

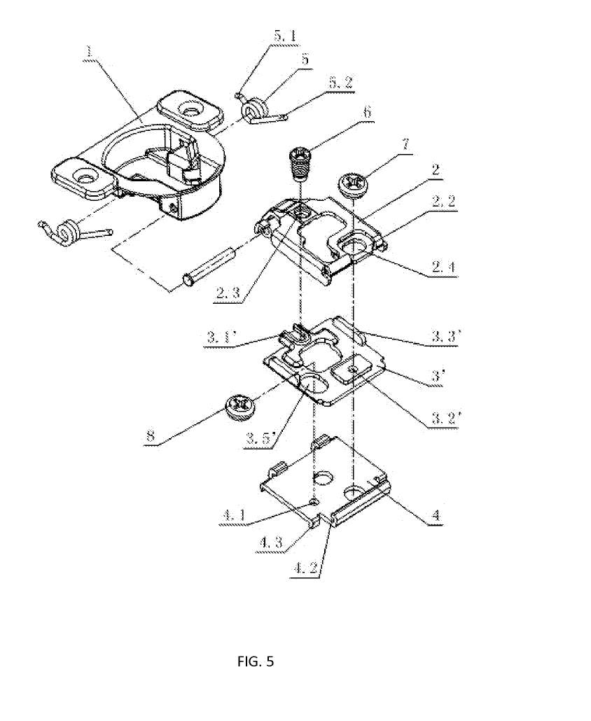

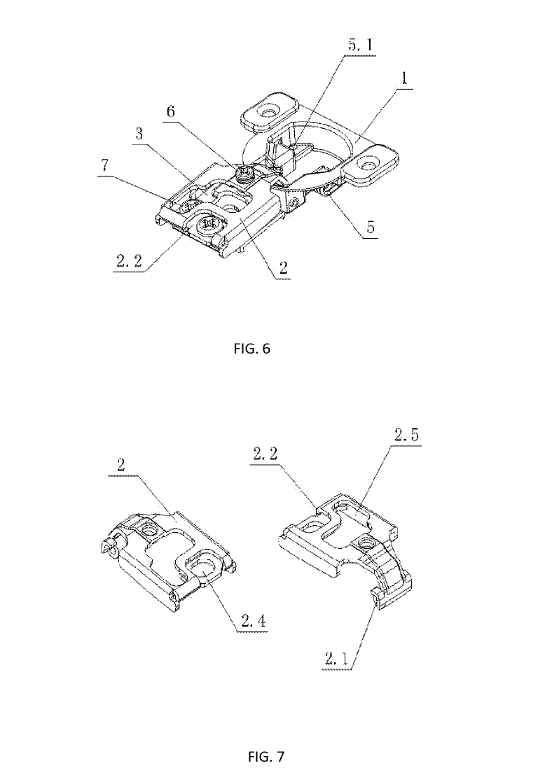

With reference to FIGS. 5-7, the present blind hinge used for furniture differs from the first embodiment in the following aspects: The regulating base is composed of a movable plate 3′ and a base plate 4, wherein the movable plate 3′ is located between the base plate 4 and the rotary arm 2, the rotary arm 2 is connected with the movable plate 3′ through the regulating screw 6 and the eccentric regulating rivet 7, the movable plate 3′ is connected with the base plate 4 through another eccentric regulating rivet 8, so as to realize the three-dimensional regulation of furniture door body.

Specifically, a open slot 3.1′ is provided on the front end of the movable plate 3′, a first regulating hole 2.3 is provided on the rotary arm 2 corresponding to the open slot 3.1′, both the open slot 3.1′ and the first regulating hole 2.3 are in coordinated connection through regulating screw 6; a hole 3.2′ is provided on the moveable plate(3), a second regulating hole 2.4 is provided on the bending part 2.2 of the rotary arm 2 corresponding to the hole 3.2′, and both the hole 3.2′ and the second regulating hole 2.4 are in coordinated connection through the eccentric regulating rivet (7). Another hole 3.5′ is also provided on the movable plate 3′, a matching hole 4.1 is provided on the base plate 4 corresponding to the hole 3.5, and both the hole 3.5′ and the matching hole 4.1 are in coordinated connection through the eccentric regulating rivet 8; one regulating screw 6 and two eccentric adjusting rivet 7,8 are in triple-lapped arrangement.

In order that more reasonable connection and regulation among the rotary arm 2, the movable plate 3′ and the base plate 4 can be realized, both sides of the rotary arm 2 are bent downwards to form a slot 2.5 which is in limiting connection with the movable plate 3′; A boss 3.3′ is provided on the movable plate 3′ and is in coordinated connection with the rotary 2; In fact, the boss 3.3′ is the bending strip formed by bending the left and right sides of the movable plate 3′ towards the direction of the rotary arm 2; the upper and lower sides of the base plate 4 are bent towards the direction of the movable plate 3′ and form a guide slot 4.2, wherein the movable plate 3′ is slideably provided on the guide slot 4.2; four corners of the base plate 4 are also bent downwards to form a blocking part 4.3, which is embedded into the main body frame of furniture to realize the positioning of the base plate 4.

The rotary arm 2, the movable plate 3′ and the base plate 4 are molded by integrated stamping and bending of metal.

### The Third Embodiment

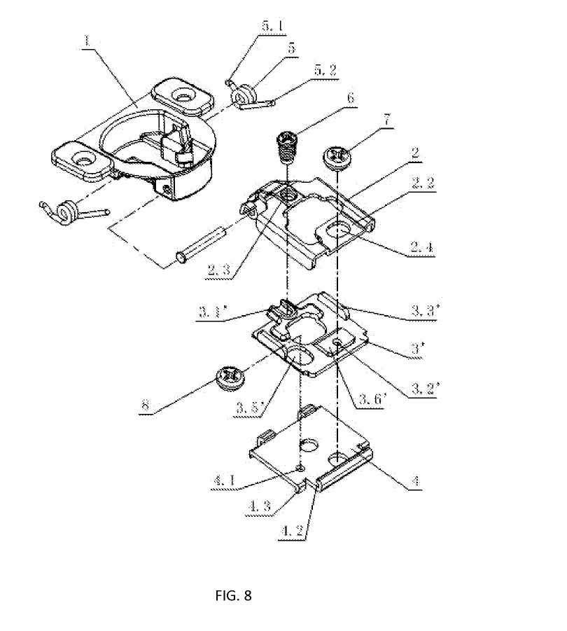

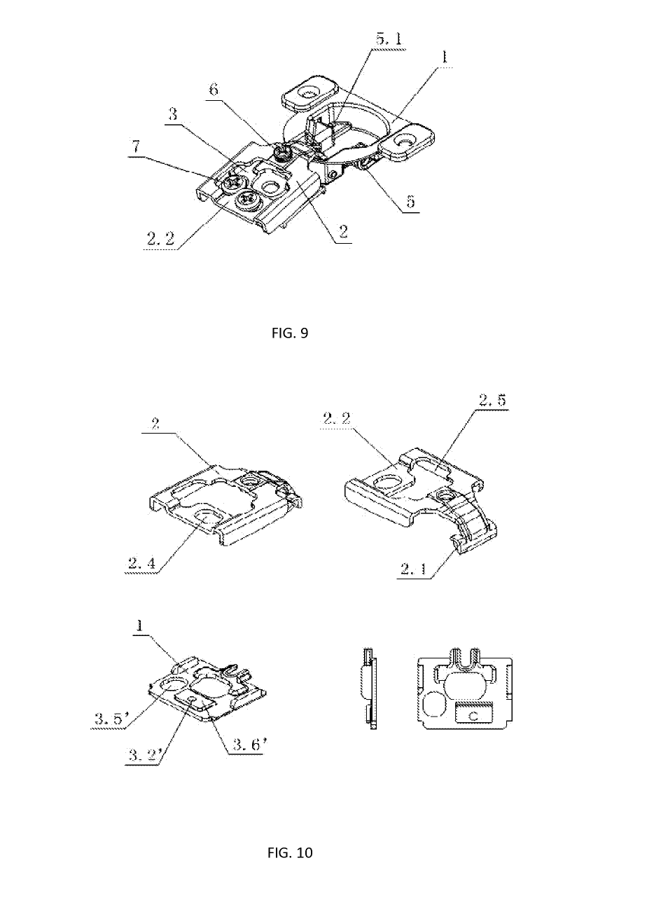

With reference to FIGS. 8-10, in the blind hinge used for furniture, the regulating base is composed of a movable plate 3′ and a base plate 4, wherein the movable plate 3′ is located between a base plate 4 and a rotary arm 2, the rotary arm 2 is connected with the movable plate 3′ through the regulating screw 6 and the eccentric regulating rivet 7; the movable plate 3′ is connected with the base plate 4 through another eccentric regulating rivet 8, so as to realize the three-dimensional regulation of furniture door body. The third embodiment differs from the second embodiment in that, the rear end of the rotary arm 2 is pressed and bent to form a slot, three sides of the rectangle boss 3.6 of the movable plate 3′ are separated from the bottom surface, and only one side is remained and connected with the bottom surface, so thon the boss 3.6 has elasticity and thus can be inclined with the bottom surface by different angles under external force.

Specifically, a open slot 3.1′ is provided on the front end of the movable plate 3′, a first regulating hole 2.3 is provided on the rotary arm 2 corresponding to the open slot 3.1′, and both the open slot 3.1′ and the first regulating hole 2.3 are in coordinated connection through the regulating screw 6; a hole 3.2′ is provided on the moveable plate 3′, a second regulating hole 2.4 is provided on the press bending part 2.2 of the rotary arm 2 corresponding to the hole 3.2′, and both the hole 3.2′ and the second regulating hole 2.4 are in coordinated connection through the eccentric regulating rivet (7). Another hole 3.5′ is also provided on the movable plate 3′, a matching hole 4.1 is provided on the base plate 4 corresponding to the hole 3.5, and both the hole 3.5′ and the matching hole 4.1 are in coordinated connection through the eccentric regulating rivet 8; one regulating screw 6 and two eccentric adjusting rivet 7, 8 are in triple-lapped arrangement.

In order that more reasonable connection and regulation among the rotary arm 2, the movable plate 3′ and the base plate 4 can be realized, both sides of the rotary arm 2 are bent downwards to form a slot 2.5 which is in limiting connection with the movable plate 3′; A boss 3.3′ is provided on the movable plate 3′ and is in coordinated connection with the rotary 2; In fact, the boss 3.3′ is the bending strip formed by bending the left and right sides of the movable plate 3′ towards the direction of the rotary arm 2; the upper and lower sides of the base plate 4 are bent towards the direction of the movable plate 3′ and form a guide slot 4.2, wherein the movable plate 3′ is slideably provided on the guide slot 4.2; four corners of the base plate 4 are also bent downwards to form a blocking part 4.3, which is embedded into the main body frame of furniture to realize the positioning of the base plate 4.

The rotary arm 2, the movable plate 3′ and the base plate 4 are molded by integrated stamping and bending of metal.

The other parts which are not described are the same as those of the first embodiment.

The preferred embodiments of the present utility model are described above. All the simple modifications or transformations made by those skilled in the art to these embodiments fall within the claims of the present utility model.

It is claimed:

1. A blind hinge used for furniture, comprising a movable cup seat (1) provided on the furniture door body, a regulating base is provided on the main body of furniture, an regulating base provided on the main body of furniture, a rotary arm connected between the movable cup seat and the regulating base as well as an elastic element designed to generate start-stop acting force on the movable cup seat (1) at least, characterized in that, the front of the rotary arm (2) is designed as similar “ [symbol] ”-shaped structure, the small end arm lever is hinged with the movable cup seat through pin shaft and forms an arc-shaped surface (2.1) connected with the elastic element; The big end top surface is a plane; a bending part (2.2) which is bent downwards on the rear end of the rotary arm is connected with the regulating base.

2. The blind hinge used for furniture of claim 1, characterized in that, the elastic element is a torsion spring (5), wherein two torsion springs are respectively mounted on the notches (1.1) on both sides at the bottom of the movable cup seat (1); The torsion spring (5) at least comprises a first supporting leg (5.1) with one end extending into the cup body of the movable cup seat (1) and being connected with it as well as a second supporting leg (5.2) with another end being extended into the cup body of movable cup seat (1) and being connected with the arc-shaped surface (2.1), wherein the free end of the first supporting leg (5.1) is bent, and its end surface is connected with the bottom wall of the movable cup seat (1).

3. The blind hinge used for furniture of claim 1, characterized in that, the regulating base is composed of a movable plate (3), wherein the rotary arm (2) is connected with the movable plate (3) through an regulating screw (6) and an eccentric regulating rivet (7), so as to realize the two-dimensional regulation of furniture door body.

4. The blind hinge used for furniture of claim 3, characterized in that, a open slot (3.1) is provided on the front end of the movable plate (3), a first regulating hole (2.3) is provided on the rotary arm (2) corresponding to the open slot (3.1), both the open slot (3.1) and the first regulating hole (2.3) are in coordinated connection through regulating screw (6); a hole (3.2) is provided on the moveable plate (3), a second regulating hole (2.4) is provided on the bending part (2.2) of the rotary arm (2) corresponding to the hole (3.2), and both the hole (3.2) and the second regulating hole (2.4) are in coordinated connection through the eccentric regulating rivet (7).

5. The blind hinge used for furniture of claim 4, characterized in that, both sides of the rotary arm (2) are bent downwards to form a slot (2.5) which is in limiting connection with the movable plate (3), a boss (3.3) is provided on the movable plate (3) and is in coordinated connection with the rotary arm (2), at least two corners of movable plate (3) are bent downwards to form a claw (3.4).

6. The blind hinge used for furniture of claim 2, characterized in that, the regulating base is composed of a movable plate (3′) and a base plate(4), wherein the movable plate (3′) is positioned between the base plate (4) and the rotary arm (2), the rotary arm (2) is connected with the movable plate (3′) through the regulating screw (6) and the eccentric regulating rivet(7), and the movable plate (3′) is connected with the base plate(4) through another eccentric regulating rivet(8), so as to realize the three-dimensional regulation to the furniture door body.

7. The blind hinge used for furniture of claim 6, characterized in that, a open slot (3.1′) is provided on the front end of the movable plate (3′), a first regulating hole (2.3) is provided on the rotary arm (2) corresponding to the open slot (3.1′), and both the open slot (3.1′) and the first regulating hole (2.3) are in coordinated connection through the regulating screw (6); a hole (3.2′) is provided on the movable plate (3′), a second regulating hole (2.4) is provided on the bending part (2.2) of the rotary arm (2.2) corresponding to the hole (3.2′), and both the hole (3.2′) and the second regulating hole (2.4) are in coordinated connection through the eccentric regulating rivet (7), another hole (3.5′) is also provided on the movable plate (3′), and a matching hole (4.1) is provided on the base plate (4) corresponding to the hole (3.5′), both are in coordinated connection through the eccentric regulating rivet (8).

8. The blind hinge used for furniture of claim 7, characterized in that, one regulating screw (6) and two eccentric regulating rivets (7,8) are in triple-lapped arrangement.

9. The blind hinge used for furniture of claim 8, characterized in that, both sides of the rotary arm (2) are bent downwards to form a slot (2.5) which is in limiting connection with the movable plate (3′); a boss (3.3′) is provided on the movable plate (3′) and is in coordinated connection with the rotary arm (2); the outside of the base plate (4) is bent towards the direction of the movable plate (3′) to form a guide slot, the movable plate (3′) is slideably provided on the guide slot (4.2), and at two corners of the base plate (4) are bent downwards to form a blocking part (4.3).

10. The blind hinge used for furniture disclosed in claim 1, characterized in that, both the rotary arm (2) and the regulating base are molded by integrated stamping and bending of metal.

11. The blind hinge used for furniture disclosed in claim 2, characterized in that, both the rotary arm (2) and the regulating base are molded by integrated stamping and bending of metal.

12. The blind hinge used for furniture disclosed in claim 3, characterized in that, both the rotary arm (2) and the regulating base are molded by integrated stamping and bending of metal.

13. The blind hinge used for furniture disclosed in claim 4, characterized in that, both the rotary arm (2) and the regulating base are molded by integrated stamping and bending of metal.

14. The blind hinge used for furniture disclosed in claim 5, characterized in that, both the rotary arm (2) and the regulating base are molded by integrated stamping and bending of metal.

15. The blind hinge used for furniture disclosed in claim 6, characterized in that, both the rotary arm (2) and the regulating base are molded by integrated stamping and bending of metal.

16. The blind hinge used for furniture disclosed in claim 7, characterized in that, both the rotary arm (2) and the regulating base are molded by integrated stamping and bending of metal.

17. The blind hinge used for furniture disclosed in claim 8, characterized in that, both the rotary arm (2) and the regulating base are molded by integrated stamping and bending of metal.

18. The blind hinge used for furniture disclosed in claim 9, characterized in that, both the rotary arm (2) and the regulating base are molded by integrated stamping and bending of metal.
